(19) United States
(12) Patent Application Publication
(10) Pub. No.: US 2015/0009977 A1
(43) Pub. Date: Jan. 8, 2015

(54) METHOD AND SYSTEM FOR MANAGING THE MOBILITY OF A MOBILE NETWORK

(71) Applicant: COMMISSARIAT A L'ENERGIE ATOMIQUE ET AUX ENERGIES ALTERNATIVES, Paris (FR)

(72) Inventors: Alexandre Petrescu, Nozay (FR); Michael Mathias Boc, Issy Les Moulineaux (FR); Christophe Janneteau, Chaudon (FR)

(21) Appl. No.: 14/377,467

(22) PCT Filed: Feb. 27, 2013
(86) PCT No.: PCT/EP2013/053966

§ 371 Date: Aug. 7, 2014

(30) Foreign Application Priority Data
Feb. 28, 2012 (FR) 1251777

(51) Int. Cl. H04W 8/08; H04W 76/02

(52) U.S. Cl. CPC H04W 8/087; H04W 76/022; H04W 84/12
USPC 370/338

(57) ABSTRACT

A system and a method are provided for managing the mobility of mobile networks in a Proxy Mobile IP domain. The method makes it possible to configure a host mobile terminal (MH) to which mobile devices LFN can be connected so that it operates in Mobile Router (MR) mode. The method applies a prefix division to the Home Network Prefix (HNP) assigned by the PMIP MH protocol in order to extract Mobile Node Prefix (MNP) sub-prefixes for configuring the addresses of the LFNs. This method does not entail any modification to the PMIPv6 protocol.

### FIELD OF THE INVENTION

The invention relates to mobile networks and more particularly the mobility of such mobile networks in a Proxy Mobile IPV6 environment.

### PRIOR ART

Internet Protocol mobility (Mobile Internet Protocol or MIP) is a communication protocol that allows a user of an independent terminal or of a user device (respectively Mobile Host MH or User Equipment UE) to move with the same IP address from an IP network of origin (mother network or Home Network HN) to another IP network (visited network or Foreign Network) while preserving its active connections. The mobility of an MH is managed by the MH itself and by fixed entities of the networks that update certain data structures relating to the unique IP address Home Address or HoA for the MH. When the protocol used is Proxy MIP (PMIP), the data relate to the prefix used to form an address.

When an MH changes its point of attachment, and Proxy MIP is used, the fixed entities reassign to the target point of attachment the same IP prefix as that of the source point of attachment. The MH then sees no modification in the layer of the IP address and its IP sessions do not need to be re-launched.

An IP network in which the mobility of the MH devices is managed by the Proxy Mobile IP protocol is called a proxy mobility or Proxy Mobile IP (PMIP) domain. Proxy mobility is specified by the Internet Engineering Task Force (IETF) in various ‘Request For Comments’ (RFC) documents. In particular, RFC 5213 defines the Proxy Mobile IPv6 (PMIPv6) protocol which can be referred to as current state of the art of Proxy mobility. This RFC uses the term Mobile Node (MN) instead of (MH) to denote the same element. This RFC is available for example at the web address http://www.rfc-editor.org/rfc/rfc5213.txt.

FIG. 1 illustrates a general architecture of a PMIPv6 (100) domain. The specification of PMIPv6 defines the use of two types of entities located in the network for managing the mobility of the MHs (102): the point of attachment Local Mobility Anchor or LAM (104) and the access router Mobile Access Gateway or MAG (106-1, 106-2).

The LMA (104) is located on a central server that allows access to an Internet (108) network for example. Its role is to manage the state of the MH sessions, the associated IPv6 prefixes—the Home Network Prefix or HNP—, the routing tables and the set-up of communication tunnels toward the MAGs.

The MAG (106-1, 106-2) is located on an IP router for accessing the PMIP network. Its role is, firstly, to store the presence of an MH (102) with the LMA (104) by sending a signaling message—Proxy Binding Update or PBU. The LMA (104) replies to this request by an acknowledgement message—Proxy Binding Acknowledgement or PBA.

The MAG (106-1) and the LMA (104) set up bi-directional communication tunnels between each other in order to transport the communications of the nodes.

The LMA (104), on receiving a PBU message, will confirm or attribute a prefix HNP that will be transmitted to the MAG (106-1) by a PBA message. The prefix attributed to an MH is then announced by the MAG over the link existing between this MAG (106-1) and the MH (102).

The other end of the communications of the MH (102) is called a Correspondent Node or CN (110). It is a fixed item of electronic equipment situated at an arbitrary place on the Internet network (108). It can be inside or outside the PMIP domain, and it communicates with the MH (102). This equipment item can typically be an application server, such as a Web server or another MH when it is inside the PMIP domain.

The Proxy Mobile IPv6 protocol allows the mobility of the MH (102) toward a new MAG (106-2), while allowing the LMA (104) to write an entry in its routing table “destinations”, containing at least one pair of variables [HNP, tunnel]. The LMA (104) transmits the packets originating from the CN (110) addressed to the MH (having the prefix HNP), in this destination tunnel. Similarly, for the same prefix HNP, the MAG (106-2) sets up an entry in its routing table “sources”, containing at least one pair of variables [HNP, tunnel].

A mobile platform or mobile network is defined as a set of devices called “Local Fixed Node (LFN)” which move together in a homogenous way. Such mobile networks are for example composed of a plurality of LFN terminals such as smart phones, portable computers, or tablet PCs for the passengers of a boat, an airplane, or a car.

Whereas the Proxy Mobile IPv6 protocol supports the mobility of the independent mobile terminals MH, it does not offer support for the mobility of the mobile networks and a mobile network cannot be hosted in a Proxy Mobile IPv6 domain. Indeed, this protocol does not manage the attribution of prefixes to form IPv6 addresses for the LFN devices included in mobile networks.

Patent application US 2011/0032874 A1 by KIM et al. presents a system (mMAG or mobile Mobile Access Gateway) for supporting mobile networks in Proxy Mobile IPv6 domains. The mMAG system comprises an address-generating entity and a communicating entity. The address generation is done by attribution of an additional prefix—Mobile Home Network Prefix or Mobile HNP—and the communication toward the mobile nodes is done by sending additional messages containing the prefix, messages named Router Advertisement Messages.

In such an approach, modifications are made to the entities of the core network, to the MAG in particular.

There is therefore a need for a Proxy Mobile IP infrastructure that supports the mobility of entire mobile platforms (or mobile networks).

Furthermore, there is a need for such an infrastructure authorizing the use of the mobile networks with the Proxy Mobile IPv6 protocol that does not affect the entities of the existing infrastructure.

The present invention meets this need.

### SUMMARY OF THE INVENTION

One subject of the present invention is to supply of a method for managing the mobility of mobile networks in PMIPv6 domains.

Another subject of the present invention is to supply of a method that does not involve any modification of the PMIPv6 protocol.

A more specific subject of the present invention is to allow a dynamic configuration of the addresses of mobile terminals attached to a mobile network.

Another subject of the present invention is to allow a mobile terminal in a mobile network to obtain a global IP address and thus to communicate with a correspondent node situated at an arbitrary position in the Internet network, or situated in the same PMIP domain.

Another subject of the present invention is to offer stable communication when a mobile router switches between two MAGs.

Advantageously but without being limiting, the invention can be applied in systems of transport—public or private—, of security and defense, and of telecommunications.

To obtain the desired results, a method and a system as described are proposed.

In particular, a method for managing the mobility of a mobile network operating in a Proxy Mobile IP (PMIP) environment comprising at least one point of attachment and an access router is proposed. The mobile network comprises a mobile terminal in communication with at least one user device. The method comprises the steps of:

setting up an IP-in-IP communication tunnel between said at least one point of attachment and access router allowing the exchange of data between the mobile terminal and a correspondent node of the PMIP environment, the communication tunnel attributing a Home Network Prefix (HNP) to the mobile terminal;

dividing (512) the attributed Home Network Prefix into a first part to form a Home Address (HoA) for the mobile terminal (102, 204), and into one or more other parts to generate one or more prefixes (P1,P2), one of the prefixes defining a Mobile Network Prefix (MNP) attributed to the mobile terminal (102,204); and

announcing the Mobile Network Prefix created to said at least one user device in such a way as to allow the exchange of data between said at least one user device and the correspondent node by way of said IP-in-IP communication tunnel.

Various variant implementations are described in the dependent claims.

### DESCRIPTION OF THE FIGURES

Various aspects and advantages of the invention will become apparent in support of the description of a preferred but non-limiting mode of implementation of the invention, with reference to the figures below:

FIG. 1 is a topological representation of a conventional architecture of the PMIPv6 domain;

FIG. 2 is a topological representation of a network architecture comprising an operator network and a mobile network in which the invention is preferably to be implemented;

FIG. 3 shows an example of division of the HNP as operated by the present invention;

FIGS. 4a and 4b show the routing tables of a mobile terminal MH and a mobile router MR;

FIG. 5 shows under a diagram of data flow type, a first example of exchange, which uses a point-to-point link, operating according to the principles of the present invention;

FIG. 6 shows under a diagram of data flow type, a second example of exchange, which uses a shared link, operating according to the principles of the present invention.

### DETAILED DESCRIPTION OF THE INVENTION

Although the description is based on the use of the Proxy Mobile IPv6 protocol, the principles described can be extended to a Proxy Mobile IP protocol independent of the version of the IP. Thus the present invention can also be applied in infrastructures using a PMIPv4 protocol that allocates prefixes.

FIG. 2 shows an architecture 200 of a mobile network operating under the PMIPv6 protocol to illustrate an implementation of the present invention. The mobile network (202) is composed of one or more user IP terminals (202-1, 202-2, 202-n), the Local Fixed Node or LFN, and of at least one mobile terminal, the Mobile Host or MH (204).

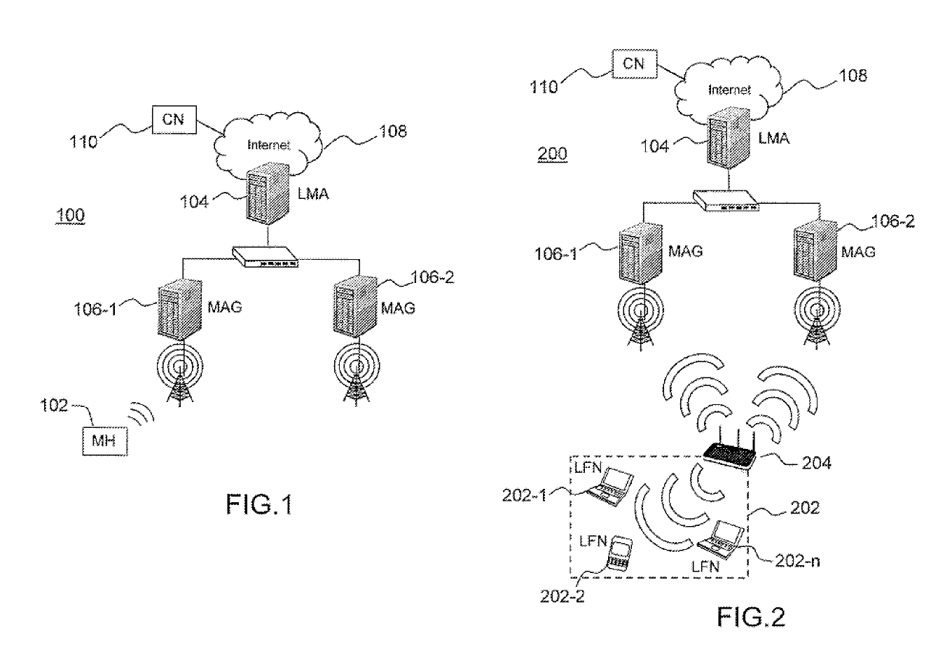

The elements present in FIG. 1 are reproduced with the same references.

The mobile terminal (204) is an electronic device equipped with at least one IPv6 interface capable of self-attributing a global IPv6 address on the basis of an IPv6 prefix announced by its access router, or else capable of being attributed an IPv6 address in response to an explicit request for an IPv6 address. In the case of the mobility of a mobile platform, the mobile terminal manages a mobile network (202) in its entirety, i.e. a network composed of LFNs. The mobile terminal is then named Mobile Router or MR, and is equipped with at least two IPv6 interfaces. As has been presented previously, the PMIPv6 protocol does not manage the mobility of the mobile networks, because it only allows the attribution of an HNP prefix to the link between the mobile terminal and the mobile network. Moreover, the protocol does not allow the attribution of a prefix that would be usable to form IPv6 addresses for the LFNs. One such prefix for forming IPv6 addresses for a mobile network is called Mobile Network Prefix or MNP.

The LFN terminals are in communication with the mobile router (204), preferably in a wireless connection mode. The user terminals can be any portable device such as portable computers, smart phones, notebooks or Personal Digital Assistants (PDA). The LFN terminals are devices that do not run any mobility management protocol.

The mobile router (204) possesses a first IP interface to a main network such as for example to a telecommunications operator network. The operator network contains fixed entities that manage the mobility of the mobile router (204). Some operator networks offer a point-to-point access to the mobile router, whereas others offer shared access. The first interface of the mobile router is called egress. Advantageously, the mobile router (204) possesses a second IP interface to the local network (202) from which the LFN terminals can be connected. This interface is called ingress.

The LFN devices move together, in a homogenous way. Such mobile networks can be incorporated into an airplane, a vehicle or a boat—each representing a typical illustration of homogenous movement of several terminals, for the passengers for example.

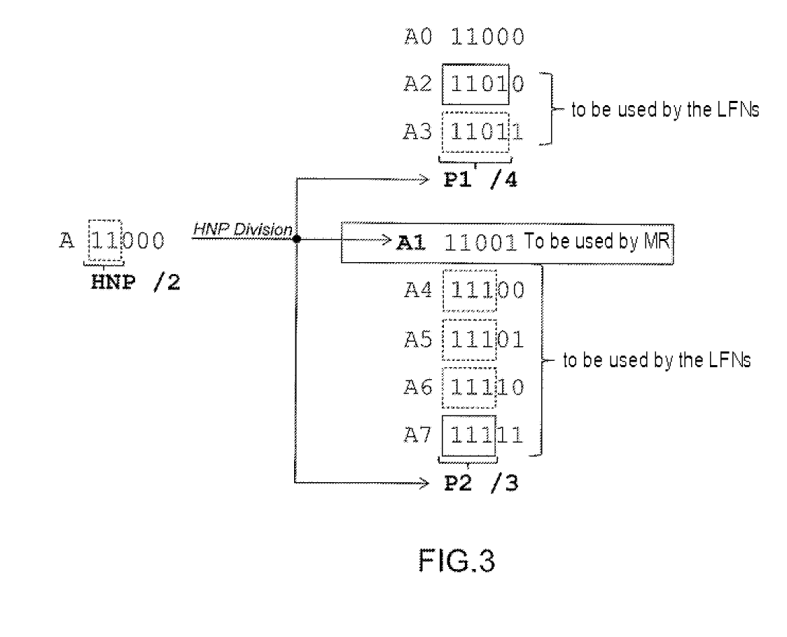

FIG. 3 shows an example of division of the HNP as operated by the invention. Advantageously the method of the present invention does not imply any extension to the existing entities of the Proxy Mobile infrastructure, whether it is to MAG entities, or LMA entities. In addition, there is no extension of new PMIPv6 messages.

Thus, the proposed method consists in using the HNP prefix as initial element to form one or more Mobile Network Prefixes (or MNPs) for the Mobile Router MR and thus to address the LFN mobile terminals. The Mobile Host operates in Mobile Router (MR) mode using two types of interface, an egress interface to the external network and an ingress interface to the mobile network.

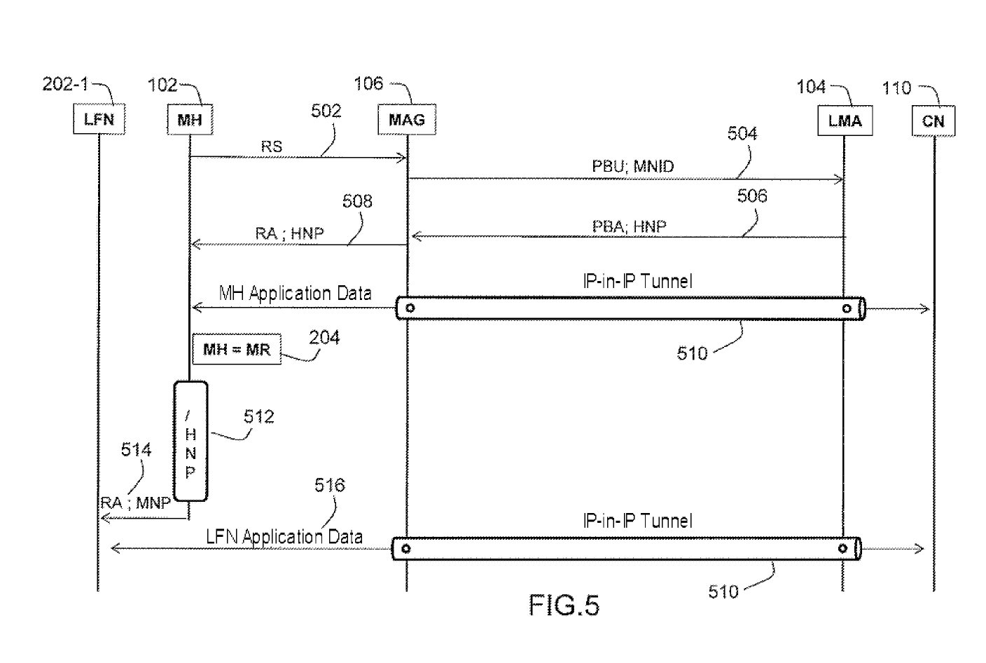

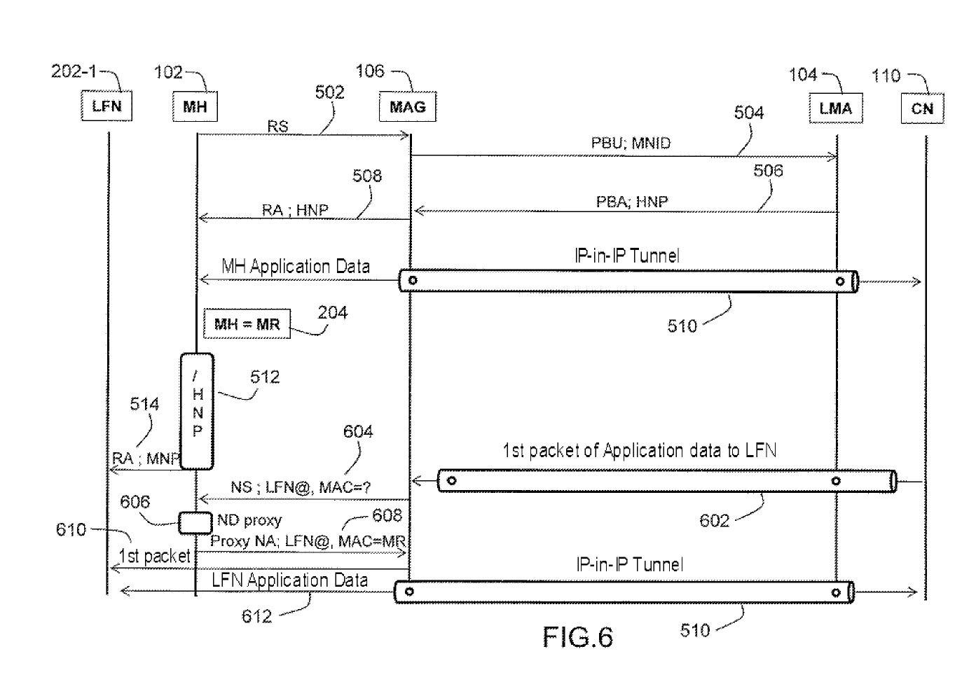

In a first step, the Mobile Router (MR) divides the HNP as received from the LMA into two parts: a first part to form an address for itself and a second part to form prefixes for the LFNs. In a following step, a process for transmitting packets is operated according to alternative modes that will be described in detail with reference to FIGS. 5 and 6.

The example in FIG. 3, for reasons of simplification of the description, shows an HNP whose address is encoded on 5 bits (11000). However, those skilled in the art will understand that the described method is applicable whatever the length of the addresses, such as a length of 64 or 128 bits.

The LMA entity attributes an HNP length 2 denoted “HNP/2”. In the framework of the RFC5213 PMIPv6, this length is attributed using the PBA message, in the “Length” field of the “Home Network Prefix” option. The mobile router MR runs a process that divides the “HNP/2” into a first address A1 (11001/5) for itself and into two prefixes “P1/4” of length 4 (1101) and “P2/3” of length 3 (111).

Subsequently, the mobile router MR announces the prefixes P1 and P2 to the LFNs in a message exchanging procedure. These LFNs use these prefixes to form LFN addresses, by adding an interface identifier of the LFN to the prefix received from the MR. The mobile router MR adds to its routing table the corresponding entries for P1 and P2 with respect to its ingress interface to the LFNs, and the entries for A1 with respect to its egress interface to the MAG. This method of forming addresses by MR with LFN (MR announces a prefix to the LFN, LFN forms the address by adding an identifier to the prefix), is known by the name of Stateless Address Auto-configuration or SLAAC and is described in the RFC 4862 standard.

Alternatively to SLAAC, the Mobile Router MR can use the prefixes P1 and P2 to form several complete addresses (of length 5) and then distribute them to the LFNs using the DHCPv6 RFC 3315 protocol, a method which is known by the name of Stateful Address Auto-configuration.

The prefix division method of the present invention is applicable to any addressing system in which the address has a fixed length and using a search algorithm in the routing tables such as the Longest Prefix Patch algorithm. Thus, the method applies for a length of HNP prefix comprised between 1 and [address length—1]. For example, in the case of an IPv6 address of a length of 128 bits, the method operates for a HNP whose length can vary between 1 and 127.

For a length HNP/x, the shortest length of the MNP obtained after application of the method of the invention is /x+1, whereas the longest is the total address length. Thus for IPv6 addresses on 128 bits and a length of HNP/64, the shortest MNP obtained by division of the HNP is of length/65 whereas the longest MNP obtained is of length/128.

For an addressing system with addresses of length L, the division of a prefix of length/H (H smaller than L) can offer between 2 and 2^{L-H} MNPs simultaneously. The length of each of these MNP prefixes can be between H+1 and L. No prefix length can be smaller than H+1 or larger than L.

Thus in the example chosen illustrated in FIG. 3, the addresses A2 (11010) and A3 (11011) of prefix “P1/4” as well as the addresses A4 (11100) to A7 (11111) of prefixes “P2/3” can be used for the LFNs present in the mobile network.

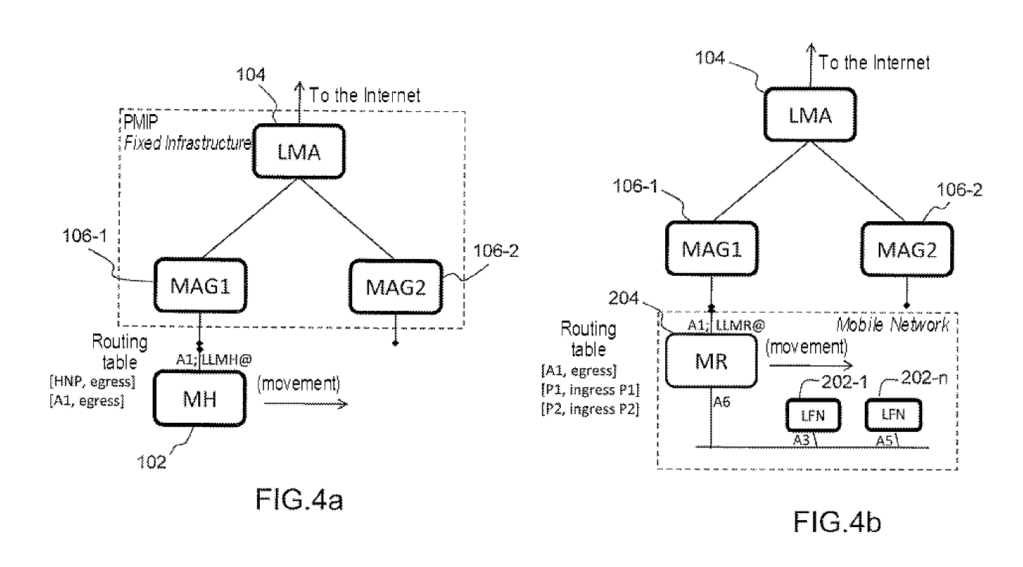

FIGS. 4a and 4b illustrate, respectively, the entries in the Routing Table for a conventional PMIP topology with Terminal Mobile Host (MH Routing Table) in FIG. 4a and for a mobile network topology with Mobile Router (MR Routing Table) and LFNs in FIG. 4b. FIG. 4b relies on the example of the division “HNP/2” in FIG. 3.

The routing table of the MH in the PMIP environment contains pairs of [prefix, next-hop] type. The contents of a pair indicates that a data packet to be transmitted whose destination address can be associated with the value of the “prefix” must be transmitted to the destination contained in the value of the “next-hop”.

As shown in FIG. 4a, the routing table of the MH contains the HNP associated with an egress value in the standard infrastructure PMIP/MH. In FIG. 4b which illustrates the use of the method of division of the HNP of the present invention, the routing table of the MR no longer contains the HNP but three other entries: [A1, egress], [P1, ingressP1] and [P2, ingressP2] relative to the address A1 and to the prefixes P1 and P2 respectively.

FIG. 4b illustrates at least two LFNs of the mobile network that will use the addresses A3 and A5 derived from P1 and P2 respectively.

Thus with the example of FIG. 3, the routing table MR will contain the values [11001/5, egress] [1101/4, egressP1] and [111/3, egressP2].

As indicated above, after the step of dividing the HNP, the transmission of packets can be carried out according to variable processes. Two variants of transmission are described where either the Mobile Terminal (MR) uses a transmission mechanism of IP-layer routing type (FIG. 5), or else a mechanism of repetition at the link layer type (FIG. 6). The transmission of IP-layer routing type uses links of point-to-point type between MAG (106) and MH (102). The transmission of repetition at the link layer type uses links of shared type between MAG (106) and MH (102). An example of a point-to-point type link is the UMTS link (3GPP, LTE) and an example of a shared type link is Ethernet (WiFi, other). The link of UMTS type is used in cellular deployments, or by a mobile telephony operator. The link of Ethernet type is used in deployments of HotSpot type.

FIG. 5 shows under a data flow type diagram a first example of exchange with a point-to-point link operating according to the principles of the present invention. As previously explained, no modification is made to the existing entities of the PMIP infrastructure, in particular to the LMA and MAG entities. The point-to-point exchange is an exchange also known by the Layer 2 Tunneling Protocol or L2TP, which combines the functionalities of the Layer 2 Forwarding or L2F protocol and the Point-to-Point Tunneling Protocol or PPTP. Another protocol is the PPP specified by RFC1661 and the IP Version 6 Over PPP specified in RFC5072.

In this type of exchange, the entries in the routing tables of the MAGs are in the form of pairs [HNP, LLMR@] where LLMR@ denotes the address of the mobile router local to the link or Link-Local Mobile Router's Address.

In an initial step (502), the mobile terminal (102) proceeds with a solicitation of the router by sending to an MAG entity (106) a Router Solicitation or RS message. The message is received by the MAG (106) which sends in step (504) a Proxy Binding Update PBU message to an LMA entity (104) with an identifier of the mobile terminal making the request, a Mobile Node Identifier or MNID.

In a following step (506), the LMA 104 allocates an HNP for the identifier (MNID), and proceeds to store this data by updating its routing tables with respect to this identifier (MNID), the HNP allocated and the soliciting MAG (106). The LMA replies to the MAG by sending a Proxy Binding Acknowledgement or PBA message containing the allocated Home Network Prefix.

At reception, the MAG updates its tables with respect to the identifier (MNID), the allocated HNP and the LMA. Then in step (508) the MAG returns to the mobile terminal (102) a Router Advertisement or RA message containing the HNP attributed by the LMA.

Next, the MH (102) uses an auto-configuration method to configure its own address. In the IPv6 environment, a method as defined in RFC4862 is known by the name Stateless Address Auto-configuration to configure an IPv6 address named Mobile Router Home Address or MR_HoA.

At this stage, any direct and bidirectional communication, initiated by MH (102) or by a correspondent node CN (110) is possible. This communication is encapsulated in an IP-in-IP tunnel (510).

The source and destination fields of this communication are MH (102) and CN (110), and the source and destination fields of the IP-in-IP tunnel are LMA (104) and MAG (106).

A communication tunnel (510) is set up between the MAG (106) and the LMA (104) which allows the mobile terminal (102) to exchange data flows originating from a correspondent node CN (110) situated in the network environment, outside the PMIP domain.

Communication between an LFN (202) and a CN (110) is not possible because as explained previously an LFN does not yet have an IP address that is topologically correct, and where applicable the LMA (104) and the MAG (106) are not configured to have knowledge of such an address in order to transmit data packets to an LFN (202).

In order to allow the routing of the data to the final user devices LFN (202), the mobile terminal will configure itself (512) to operate as a mobile router that will be named MR (204). The HNP is divided into a Home Address (HoA) for the mobile terminal/Router (102/204) that will be named an MR-HoA and into two prefixes (P1, P2) of predefined length (L1, L2) for the LFNs.

The length of the Home Address is preferably equal to the encoding length of the addresses of the PMIP network. Thus in PMIPv6, where the addresses are encoded on 128 bits, the length of the Home Address of the mobile Terminal/Router is of 128 bits.

One of the two prefixes generated is a Mobile Network Prefix or MNP which will be used by an LFN (202).

The mobile router (MR) updates its routing tables with respect to the Home Address and to the two prefixes P1 and P2 in such a way that P1 and P2 are announced to the LFN on one or two ingress interfaces, and that the Home Address is used only as source address of the only applications executed on MR.

In the next step (514), the mobile router MR (102) sends one or more RA or Router Advertisement messages on one or 2 ingress interfaces, containing the MNP prefixes for the LFNs.

On receiving the RA message, an LFN (202) carries out an auto-configuration procedure to generate an IP address for itself. Preferably, in IPv6, the procedure is known as Stateless Address Auto-configuration.

Once the IP address is generated, the bidirectional communication (516) of application data between the CN (110) and the LFN (202) is possible. There has been no new PMIP message created, nor any modification to the existing PMIP messages.

The address of the LFN (202) being part of the prefix extracted from the HNP, the LMA (104) and MAG (106) tables implicitly know the topological position of this address by executing a known Longest Prefix Match algorithm.

FIG. 6 shows under a data flow type diagram a second example of exchange of shared links, operating according to the principles of the present invention. In this example, the data exchange mechanism is of Neighbor Discovery Proxy or ND proxy type.

In this type of exchange, the entries in the routing tables of the MAGs are in the form of generic pairs [HNP, *] sometimes called connected routes.

The initial procedure of obtaining the HNP is identical to that described for FIG. 5, and will not be described again, the same reference numbers being retained for the entities (202-1, 102, 104, 106, 110) as well as for the steps of the procedure from (502) to (514).

Next when the MAG receives a data packet (602) originating from the LMA intended for a LFN, it initiates (604) a Neighbor Solicitation or NS message to receive the MAC address of the destination. This information is useful to ensure that the destination is indeed directly connected to the MAG. The mobile router (MR) acts as an LFN by replying directly to the MAG while inserting its own MAC address into the reply message (proxy neighbor advertisement). Thus, the MR consists in making the MAG believe that the IPv6 addresses used by the LFN or LFNs originate from the same MAC address, i.e. that of the MR.

In a variant implementation, it is possible to incorporate a process of dynamic switching for the mobile router (MR) between the two types of data exchange (routing and ND proxy). The process allows the mobile router (MR) to detect what type of entry is used by the MAG, entries of [HNP, LLMR@] type or generic entries of [HNP, *] type. According to the type of entry detected, the router behaves either as a conventional router or as an “ND proxy” router.

To detect the type of entry, the (MR) listens to the messages on its egress interface. If one of the messages is a Neighbor Solicitation which contains in the “destination” field an address corresponding to the MNP prefix obtained in step (512) by the HNP division, then the MR considers that the MAG is using a generic entry of [HNP, *] type. The (MR) then executes the ND Proxy procedure of steps 602 to 612 and replies to any request for an NS message emitted by the MAG for an address of the LFN by offering its own MAC address.

If the (MR) does not receive a Neighbor Solicitation message during a predefined time period the (MR) considers that the MAG is using entries of [HNP, LLMR@] type and executes the procedure previously described in FIG. 5.

It is beneficial to recall a few major advantages of the proposed solution. The MH, in becoming a mobile router MR, allows the support of mobile networks. No modification is required of the entities of the core network, which has the operational advantage of being able to continue to use the PMIPv6 protocol as well as the addressing configurations already installed. There are no new entities to be installed, configured and maintained. The present invention consists in developing extensions to the MH exclusively to make it operate as a mobile router and thus to use at least two IP interfaces.

The present invention can be implemented on the basis of hardware and/or software elements. It can be available as computer program product on a computer-readable medium.

The medium can be electronic, magnetic, optical, electromagnetic or be a broadcasting medium of infrared type. Such media are, for example, semiconductor memories (Random Access Memory RAM, Read-Only Memory ROM), tapes, diskettes or magnetic or optical disks (Compact Disk-Read Only Memory (CD-ROM), Compact Disk-Read/Write (CD-R/W) and DVD).

Thus the present description illustrates a preferred implementation of the invention, but is not limiting. An example has been chosen to allow a good understanding of the principles of the invention, and a concrete application, but it is in no way exhaustive and must allow those skilled in the art to make modifications and variant implementations while keeping the same principles.

1. A method for managing the mobility of a mobile network operating in a Proxy Mobile IP (PMIP) environment comprising at least one point of attachment and an access router, said mobile network comprising a mobile terminal in communication with at least one user device, the method comprising the following steps:
setting up an IP-in-IP communication tunnel between said at least one point of attachment and access router allowing the exchange of data between the mobile terminal and a correspondent node of the PMIP environment, the communication tunnel attributing a Home Network Prefix (HNP) to the mobile terminal;
dividing the attributed Home Network Prefix into a first part to form a Home Address (HoA) for the mobile terminal, and into one or more other parts to generate one or more prefixes (P1,P2), one of the prefixes defining a Mobile Network Prefix (MNP) attributed to the mobile terminal; and
announcing the generated Mobile Network Prefix to said at least one user device in such a way as to allow the exchange of data between said at least one user device and the correspondent node by way of said IP-in-IP communication tunnel.

2. The method as claimed in claim 1, wherein the step of setting up a PMIP communication tunnel comprises the steps of:
emitting a message (RS) soliciting an attachment of the mobile terminal to said at least one access router; and
receiving from the access router a message (RA) containing a Home Network Prefix for the mobile terminal.

3. The method as claimed in claim 2, comprising after the emitting step the step of:
signaling the presence of the mobile terminal to said at least one point of attachment by a Proxy Binding Update (PBU) message; and
receiving from said at least one point of attachment a Proxy Binding Acknowledgement (PBA) message containing the Home Network Prefix for the mobile terminal.

4. The method as claimed in claim 3, wherein the division step comprises the steps of:
identifying whether the address of the access router in the message (RA) containing the Home Network Prefix is of Link-Local Mobile Router's Address type (LLMR@); and if so
updating the routing table of the mobile terminal with the Home Address and said prefixes (P1,P2).

5. The method as claimed in claim 4, comprising the following step, if the address of the access router is not of (LLMR@) type:
initiating a Neighbor Solicitation (NS) message to obtain the MAC address of the destination.

6. The method as claimed in claim 1, wherein the announcing step comprises the step of sending a Router Advertisement (RA) message comprising the MNP to said at least one user device.

7. The method as claimed in claim 1, wherein the Proxy Mobile IP environment is a PMIPv6 environment.

8. The method as claimed in claim 1, wherein said Home Address is of equal length to the encoding length of the addresses of the PMIP network.

9. The method as claimed in claim 1, wherein said at least one user device belongs to the group of devices (portable computer, tablet PC, mobile phone).

10. A system for managing the mobility of a mobile network operating in a Proxy Mobile IP (PMIP) environment, said mobile network comprising a mobile terminal in communication with at least one user device, the system comprising means for implementing the steps of the method as claimed in claim 1.

11. A mobile terminal capable of communicating with at least one user device in a Proxy Mobile IP (PMIP) environment, the mobile terminal comprising the system as claimed in claim 10.

12. A computer program product, said computer program comprising code instructions making it possible to carry out the steps of the method as claimed in claim 1, when said program is executed on a computer.
